(19) United States
(12) Patent Application Publication
(10) Pub. No.: US 2025/0355701 A1
(43) Pub. Date: Nov. 20, 2025

(54) SYSTEMS AND METHODS FOR PROVIDING ENTROPY TO CLIENTS

(71) Applicant: Wells Fargo Bank, N.A., San Francisco, CA (US)

(72) Inventors: Abhijit Bhima Rao, Irvine, CA (US); Jeff J. Stapleton, O'Fallon, MO (US); Peter Bordow, Fountain Hills, AZ (US)

(21) Appl. No.: 18/666,282

(22) Filed: May 16, 2024

(51) Int. Cl. G06F 9/48; G06F 7/58

(52) U.S. Cl. CPC G06F 9/4881; G06F 7/588

(57) ABSTRACT

Systems and methods are disclosed herein for providing entropy to clients. An example method includes receiving a first datagram comprising a first request for entropy and a set of requirements comprising an indication of an endpoint device, an indication of a number of bits of entropy, and an indication of a quality of the entropy. The example method further includes determining, by routing circuitry, whether a first entropy source from a set of entropy sources meets the set of requirements and determining, by priority circuitry, a first priority value based on the first request. The example method further includes determining, by the priority circuitry, whether the first priority value is a greatest available priority value and causing generation, by entropy quality circuitry, of an admixture of a plurality of entropy sources from the set of entropy sources. The example method further includes providing the admixture to the endpoint device.

### BACKGROUND

Randomness is essential for various computing tasks, where its source is referred to as entropy. High-quality, or true random entropy is needed to ensure reliable performance for various operating system functions and cryptographic primitives. However, sources of high-quality entropy may provide limited output, requiring budgeting and/or services sharing among consumers of entropy.

### BRIEF SUMMARY

Random numbers in computing are used in several important applications, most notably for security, as mentioned above. Broadly speaking, the quality of the source entropy corresponds to the level of security provided by the security application that utilizes the random numbers derived from the entropy, as low-quality entropy (entropy corresponding to low randomness) includes patterns which may be learned and exploited by a potential attacker. Further, low entropy yielding not-so-random numbers (e.g., based on a low-quality random seed) can affect applications such as those for weather forecasts, traffic patterns, metal fatigue, and the like, impacting business decisions.

Entropy may have various characteristics such as quality, or how close the entropy source is to truly random data. Quality may be tested over various timescales, where validating a higher level of quality consumes greater computing resources and time. Other characteristics of an entropy source include the frequency or rate or delivery, the age of the random numbers, and the level, degree, and/or type of quality assurance testing provided.

While entropy at a quality that is reasonably tolerated for certain applications (personal use, low-profile, etc.) may be generated using a low-cost method such as measuring signals from a peripheral device (e.g., measurements of random mouse movements, voltage fluctuations, temperature fluctuations, etc.), applications that demand higher standards of security typically use sources of entropy that are high-quality, secure, and tested to assure the reported quality. Such sources of high-quality entropy may be limited within an organization and may be on-premises or off-premises (e.g., provided via a cloud service). Often local random number services run low on entropy and either block applications from getting random numbers or repeat previously offered random numbers.

Traditionally, it has been difficult to scale solutions with limited sources of high-quality entropy to large organizations, particularly where the instantaneous demand for high-quality entropy may overtake the available supply. Some solutions might block the random number request while others respond with repeated numbers. Currently there is no solution available for providing high availability, resiliency, and resource sharing commonly called load balancing and quality of service for organizations seeking to distribute entropy from multiple high-quality entropy sources, which each may provide varying qualities of entropy, to a number of endpoints with varying demands for entropy of various qualities that may change from moment to moment.

In contrast, example methods disclosed herein utilize an architecture for mixing and providing quality assurance of entropy streams that meet the demands of users in real time. Example systems ingests multiple sources of entropy, which may be a combination of on-premises and off-premises (e.g., vendor-provided) entropy sources. The entropy sources may have varying characteristics, and the characteristics may be known or unknown. Example systems provides a service via an API or other front end for calls from end nodes with varying entropy requirements. Example systems may also split and recombine entropy streams to optimally provide entropy to clients.

An example system architecture provides high throughput entropy through an API, gRPC, graphQL, and/or other similar mechanism that may allow software components to communicate to users by combining and using entropy sources while using the existing sources as efficiently as possible under the given demand. The architecture may also automate testing and quality measurement for certain incoming and/or outgoing entropy streams for certain applications where a high degree of quality assurance is desired.

Example systems also include an entropy “market maker” that determines how to best distribute the available entropy at each quality level to the demands placed on the system. Entropy providers may have a fixed or limited rate of entropy production, and the available rates may depend on the quality demanded. In some instances, demand for entropy of a particular quality may exceed the supply, and a system should be in place to determine how to distribute the limited resources available. The market maker system may have defined high-level priorities or directives that may determine how entropy is to be distributed to different lines of business, during different times or dates, or in different operation modes, for example. The service may also take steps to account for cases where providers go offline or become compromised, redirecting entropy providers and streams of information to balance load based on demand.

Accordingly, the present disclosure sets forth systems, methods, and apparatuses that provide entropy to clients. The advantages of example techniques disclosed herein include improved throughput of entropy from sources to endpoints where the entropy is needed, reducing downtime for endpoints with blocking entropy needs. Costs associated with procuring high-quality entropy may also be reduced, as entropy is less likely to be wasted on endpoints that do not require high-quality entropy. Furthermore, by recording and logging entropy requests of various qualities from an organization, abnormal entropy requests may be logged as indication of suspicious activity related to security applications, providing an additional data point for network security analysis.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for providing entropy to clients in accordance with some example embodiments described herein.

FIG. 2 illustrates a schematic block diagram of example circuitry embodying an entropy service load balancing system that may perform various operations in accordance with some example embodiments described herein.

FIG. 3 illustrates an example flowchart for providing entropy to clients, in accordance with some example embodiments described herein.

FIG. 4 illustrates another example flowchart for providing admixtures of entropy, in accordance with some example embodiments described herein.

FIG. 5 illustrates another example flowchart for providing entropy to clients, in accordance with some example embodiments described herein.

FIG. 6 illustrates another example flowchart for testing entropy quality, in accordance with some example embodiments described herein.

FIG. 7 illustrates a block diagram indicating interactions among example systems in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “entropy” as used herein refers to randomness, typically encoded as a string of bits, which may be utilized for various computing tasks such as operating system operations, cryptographic primitives, simulations, or other computational operations. Entropy may be derived from any of a number of true random physical sources which may vary in quality, such as random movements of a mouse on a personal computer or sources based on quantum noise from measurements of quantum mechanical processes.

The term “datagram” as used herein refers to any electronic transmission of data, such as a data packet. A datagram may typically include a data payload and additional information, such as a header, used to direct and/or facilitate the transmission and reception of the datagram. For example, a datagram may be a packet transmitted at any point on the open systems interconnection (OSI) stack. The datagram may originate, for example, at an application level, data link layer (DLL), or at any other point in the stack. The datagram may likewise be received and/or fulfilled at any layer in the OSI stack. It will be understood that datagrams as described herein may or may not adhere to any standards for network communication known in the art, and thus the term datagram as used herein may refer generally to electronic transmission of data in a variety of contexts.

### System Architecture

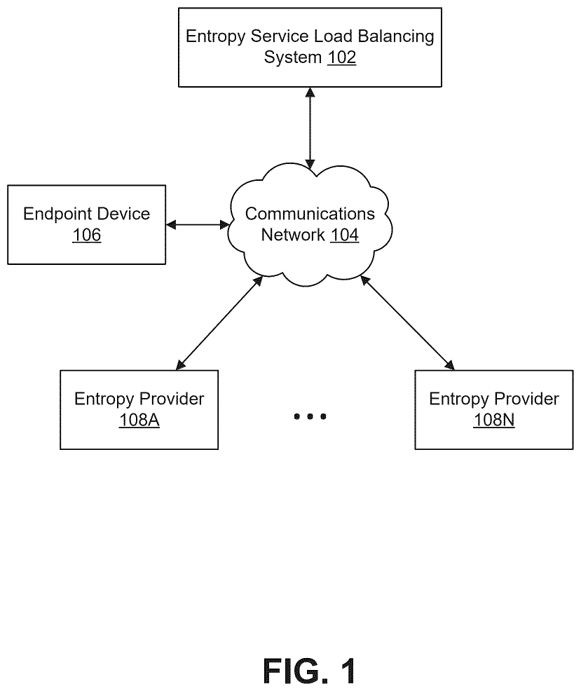

Example embodiments described herein may be implemented using any of a variety of computing devices or servers. To this end, FIG. 1 illustrates an example environment within which various embodiments may operate. As illustrated, an entropy service load balancing system 102 may receive and/or transmit information via communications network 104 (e.g., the Internet) with any number of other devices, such as endpoint device 106.

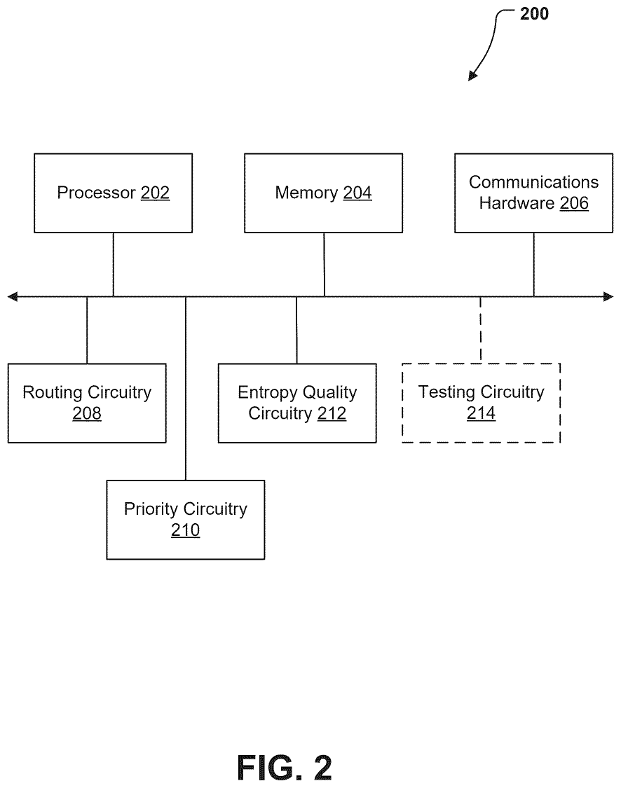

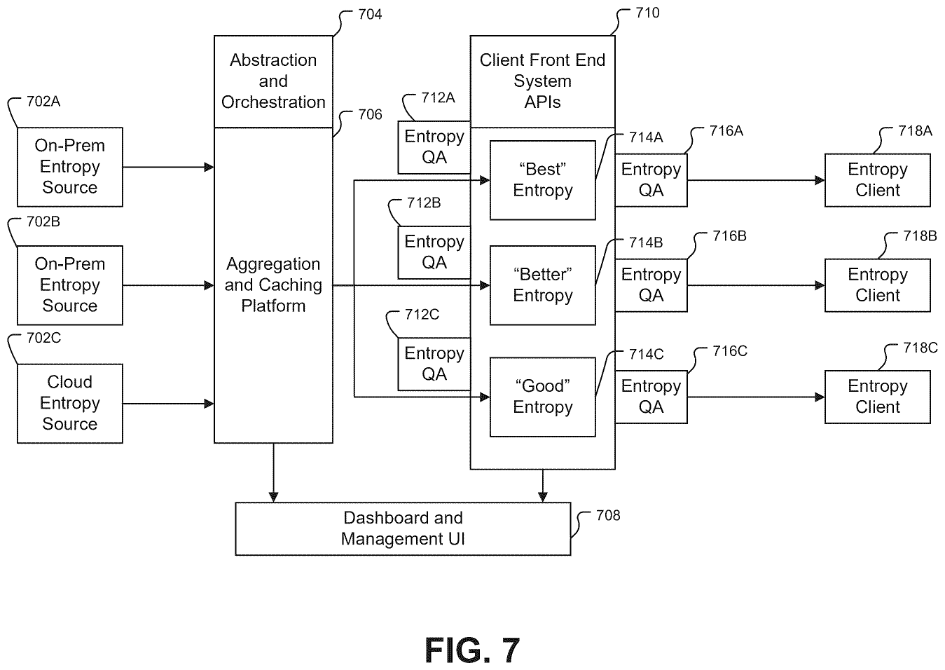

The entropy service load balancing system 102 may be implemented as one or more computing devices or servers, which may be composed of a series of components. Particular components of the entropy service load balancing system 102 are described in greater detail below with reference to apparatus 200 in connection with FIG. 2. In terms of entities depicted in FIG. 7, the entropy service load balancing system 102 may embody functions related to abstraction and orchestration 704, aggregation and caching platform 706, dashboard and management UI 708, and/or client front end system APIs 710.

The endpoint devices 106 may be embodied by any computing devices known in the art. The endpoint device 106 need not be an independent device but may be embodied as one or more peripheral devices communicatively coupled to other computing devices.

The entropy provider 108A through entropy provider 108N offer one or more entropy sources using hardware-based and/or software-based solutions including quantum-based solutions. For example, entropy provider 108A through entropy provider 108N may be a hardware true random number generator (TRNG), such as a device relying on thermal noise, Brownian motion, or atmospheric noise. A TRNG may rely on quantum effects, including the photoelectric effect or nuclear decay, for example. Complex systems exhibiting chaotic behavior with noisy inputs may also provide a TRNG. The entropy provider 108A through entropy provider 108N themselves may be TRNG devices coupled to computing devices in communication with communication network 104, or may themselves be peripheral random number generation devices or services connected to one or more server computing devices.

### Example Implementing Apparatuses

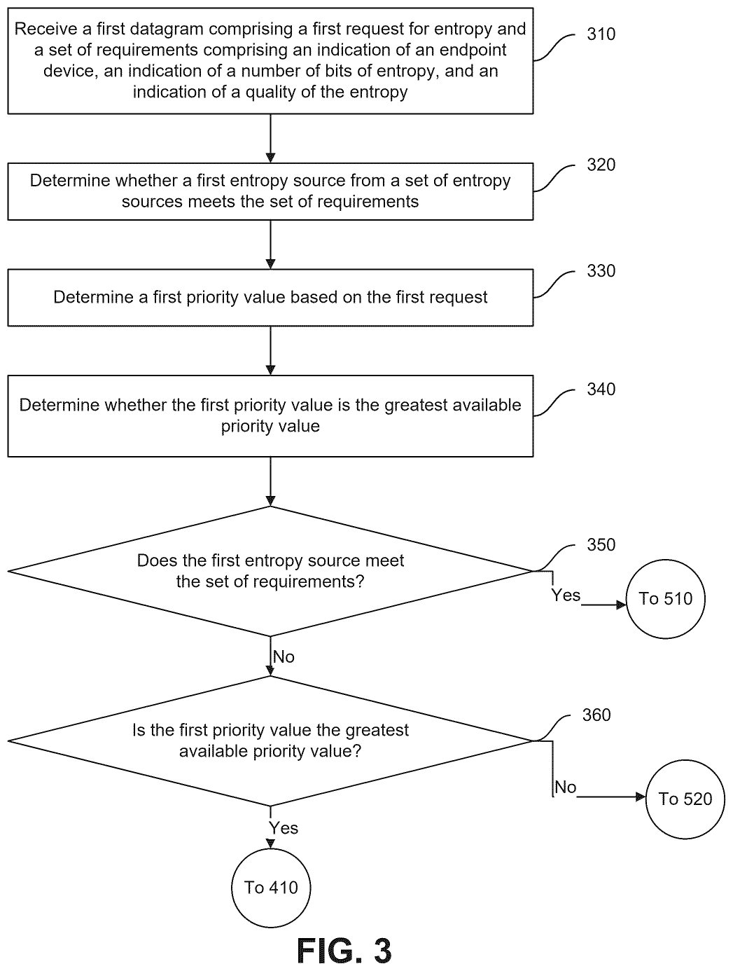

The entropy service load balancing system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-6. As illustrated in FIG. 2, the apparatus 200 may include processor 202, memory 204, communications hardware 206, routing circuitry 208, priority circuitry 210, and entropy quality circuitry 212 each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a routing circuitry 208 that determines an available entropy source to fulfill a request for entropy. The routing circuitry 208 may utilize processor 202, memory 204, or any other hardware component included in the apparatus 200 to perform these operations, as described in connection with FIGS. 3-6 below. The routing circuitry 208 may further utilize communications hardware 206 to gather data from a variety of sources (e.g., endpoint device 106, shown in FIG. 1), and/or exchange data with a user, and in some embodiments may utilize processor 202 and/or memory 204 to determine an entropy source for a request.

In addition, the apparatus 200 further comprises a priority circuitry 210 that determines priority of various entropy requests. The priority circuitry 210 may utilize processor 202, memory 204, or any other hardware component included in the apparatus 200 to perform these operations, as described in connection with FIGS. 3-6 below. The priority circuitry 210 may further utilize communications hardware 206 to gather data from a variety of sources (e.g., endpoint device 106, as shown in FIG. 1), and/or exchange data with a user, and in some embodiments may utilize processor 202 and/or memory 204 to determine request priority.

In addition, the apparatus 200 further comprises an entropy quality circuitry 212 that determines admixtures of entropy streams of varying quality. The entropy quality circuitry 212 may utilize processor 202, memory 204, or any other hardware component included in the apparatus 200 to perform these operations, as described in connection with FIGS. 3-6 below. The entropy quality circuitry 212 may further utilize communications hardware 206 to gather data from a variety of sources (e.g., endpoint device 106, as shown in FIG. 1), and/or exchange data with a user, and in some embodiments may utilize processor 202 and/or memory 204 to prepare mixed streams of entropy.

In addition, the apparatus 200 may further comprise a testing circuitry 214 that measures and tests quality of an entropy source. The testing circuitry 214 may utilize processor 202, memory 204, or any other hardware component included in the apparatus 200 to perform these operations, as described in connection with FIGS. 3-6 below. The testing circuitry 214 may further utilize communications hardware 206 to gather data from a variety of sources (e.g., endpoint device 106, as shown in FIG. 1), and/or exchange data with a user, and in some embodiments may utilize processor 202 and/or memory 204 to test entropy quality.

Although components 202-214 are described in part using functional language, it will be understood that the particular implementations necessarily include the use of particular hardware. It should also be understood that certain of these components 202-214 may include similar or common hardware. For example, the routing circuitry 208, priority circuitry 210, entropy quality circuitry 212, and testing circuitry 214 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the routing circuitry 208, priority circuitry 210, entropy quality circuitry 212, and testing circuitry 214 may leverage processor 202, memory 204, or communications hardware 206 as described above, it will be understood that any of routing circuitry 208 and priority circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that routing circuitry 208 and priority circuitry 210 comprise particular machinery designed for performing the functions described herein in connection with such elements of apparatus 200.

In some embodiments, various components of the apparatuses 200 may be hosted remotely (e.g., by one or more cloud servers) and thus need not physically reside on the apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of flowcharts.

### Example Operations

Turning to FIGS. 3, 4, 5, and 6, example flowcharts are illustrated that contain example operations implemented by example embodiments described herein. The operations illustrated in FIGS. 3-6 may, for example, be performed by the entropy service load balancing system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, routing circuitry 208, priority circuitry 210, entropy quality circuitry 212, testing circuitry 214 and/or any combination thereof. It will be understood that user interaction with the entropy service load balancing system 102 may occur directly via communications hardware 206 or may instead be facilitated by a separate endpoint device 106, as shown in FIG. 1, and which may have similar or equivalent physical componentry facilitating such user interaction.

Turning first to FIG. 3, example operations are shown for providing entropy to a client. As shown by operation 310, the apparatus 200 includes means, such as memory 204, communications hardware 206, or the like, for receiving a first datagram comprising a first request for entropy and a set of requirements, where the set of requirements include an indication of an endpoint device, an indication of a number of bits of entropy, and an indication of a quality of the entropy. The communications hardware 206 may receive the first datagram and decode, decrypt, and/or otherwise interpret the first datagram to receive the set of requirements. The set of requirements may be a data structure, unformatted data, or other indication that the communications hardware 206 may further interpret to determine the indication of the endpoint device the indication of the number of bits of entropy, and the indication of the quality of the entropy.

The indication of the endpoint device may be a network address, host name, or other data identifying a computing device accessible by network communications. In some instances, the endpoint device may be the same device that provides the first datagram to the apparatus 200. The communications hardware 206 may identify the sender of the first datagram to identify the endpoint device if no indication of an endpoint device is specified in the first datagram.

The indication of the number of bits of entropy may be an integer or other data representing the number of bits of entropy, or an equivalent indication (e.g., a duration of time and a rate of data transmission). The communications hardware 206 may convert and/or reformat the indication of the number of bits of entropy to a standard representation.

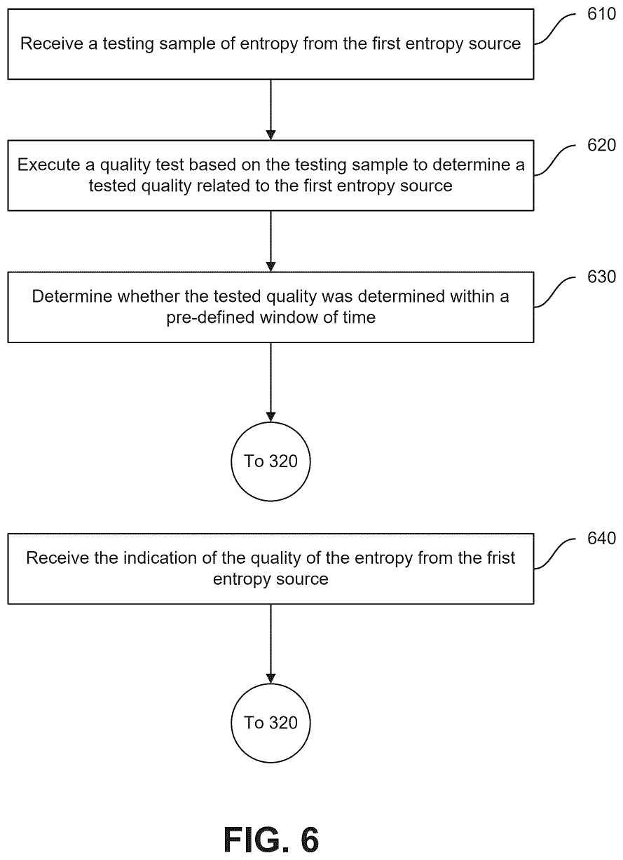

The indication of the quality of the entropy may be a selection from a list of possible quality values (e.g., “good quality”, or “excellent quality”), a numerical value (e.g., indicating a value of correlation or other measures of true randomness), or any other indication of entropy quality. The indication of quality may indicate a measure of the “true randomness” of the entropy source, so that a lower quality value indicates more predictable, correlated data than a greater quality value. The determination of quality of an entropy source may be performed, for example, as described below in connection with FIG. 6. In some embodiments, the indication of quality may be a distribution with specified parameters, such as a normal distribution where the mean and standard deviation are specified. The indication of quality may further include a bias parameter to be added to the output random values.

As shown by operation 320, the apparatus 200 includes means, such as memory 204, communications hardware 206, routing circuitry 208, or the like, for determining whether a first entropy source from a set of entropy sources meets the set of requirements. The first entropy source may be provided by a device, such as one of entropy provider 108A through entropy provider 108N. The apparatus 200 may access a list of potential entropy sources, for example, which may be stored in memory 204 or retrieved via communications hardware 206. The routing circuitry 208 may process the requirements and determine which, if any, of the entropy sources meet each of the requirements, starting with the first entropy source. The first entropy source may be the first in a loop or iteration over a list of entropy sources. The routing circuitry 208 may take into account both intrinsic properties of the first entropy source (e.g., output rate, maximum quality, average quality, and the like) and properties related to the current condition of the first entropy source (e.g., uptime or downtime, network connection availability, network status, and the like) when making the determination.

As shown by operation 330, the apparatus 200 includes means, such as memory 204, priority circuitry 210 or the like, for determining a first priority value based on the first request. The priority circuitry 210 may evaluate the request based on a pre-defined function for determining priority. The function for determining priority may be specified by a user when configuring the apparatus 200 or may be a built-in function for determining priority. The priority circuitry 210 may determine priority based on various features of the request for entropy, including contents of the first datagram, characteristics of the device sending the first datagram, characteristics of the endpoint device, and/or the like. For example, an organization may prioritize research activities from a particular line of business and may provide a priority function that gives higher priority to devices with network addresses matching the prioritized line of business. The priority may be expressed as a numerical value.

In some embodiments, the priority circuitry 210 may take into account past activities and past requests for entropy. The priority circuitry 210 may use more complex methods to determine priority, including machine learning and/or artificial intelligence, or may use simpler functions and rules-based determinations. In some embodiments, the priority circuitry 210 may use various quality-of-service and/or market-making algorithms to effectively distribute priority to requests based on established quality-of-service provider techniques. For example, frequent requests for high-quality entropy may degrade the priority of subsequent requests over time.

As shown by operation 340, the apparatus 200 includes means, such as memory 204, priority circuitry 210, or the like, for determining whether the first priority value is the greatest available priority value. The priority circuitry 210 may maintain a list of active requests, using memory 204, for example. When receiving a new request and determining the priority, the priority circuitry 210 may determine if the new request has the greatest priority. In instances where no other requests are active, the new request may automatically be determined to have the greatest priority. The greatest priority may be determined by find the numerically greatest priority value.

As mentioned, the priority circuitry 210 may maintain a list of active requests, or a queue of requests for entropy. The priority circuitry 210 may adjust priority values of various requests on the queue dynamically based on availability of entropy sources. For example, a particular entropy provider 108A may experience downtime, causing priority circuitry 210 to reduce the priority of requests that rely on entropy provider 108A, in order to clear the queue of other requests that are able to be fulfilled. In some embodiments, entropy requests may include a time-to-live (TTL) value, which may indicate how long a request may persist in the queue before the request must be responded to with an error or a completion of the entropy request.

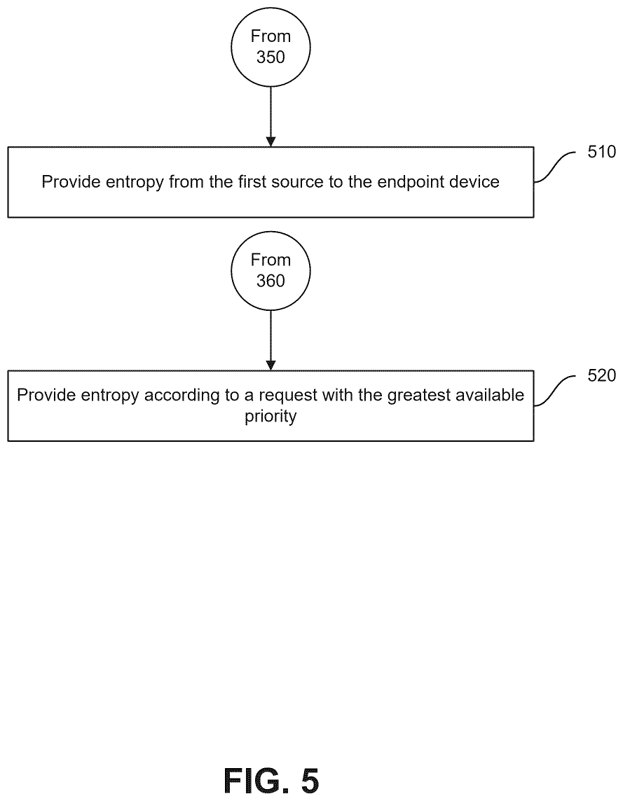

As shown by decision block 350 control may depend on determining whether the first entropy source meets the set of requirements, as determined, for example, in operation 320. In instances where the first entropy source meets the set of requirements, control may pass to operation 510 of FIG. 5. In instances where the first entropy source does not meet the set of requirements, control may pass to decision block 360.

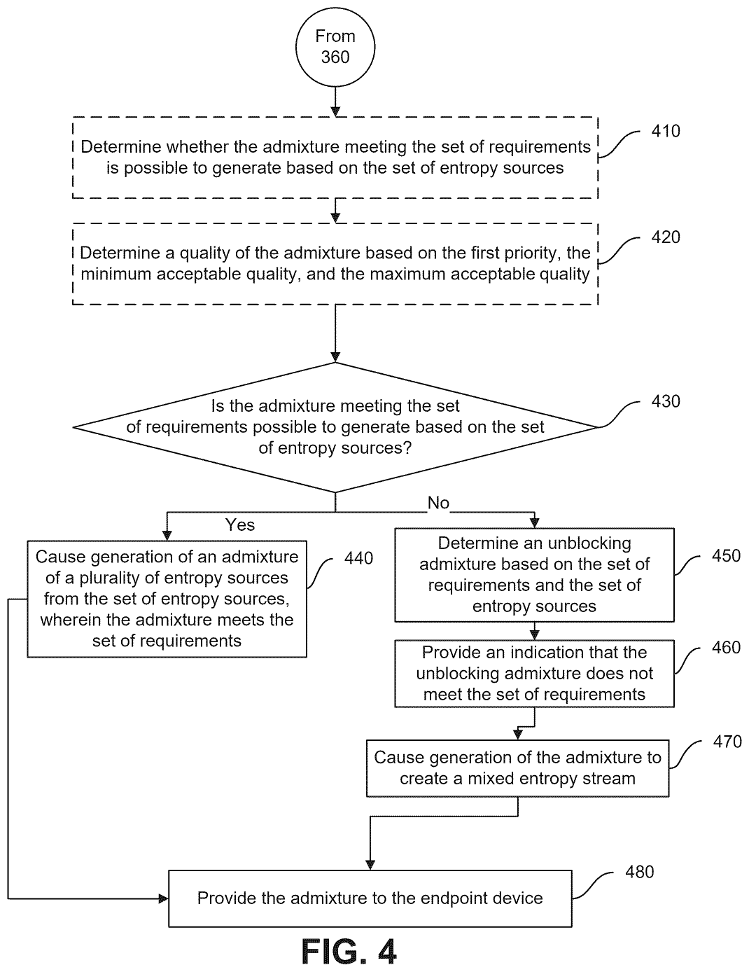

As shown by decision block 360, control may depend on determining whether the first priority value is the greatest available priority value, as determined, for example, in operation 340. In instances where the first priority is the greatest priority value, control may pass to operation 410 of FIG. 4. In instances where the first priority is not the greatest priority value, control may pass to operation 520 of FIG. 5.

Turning now to FIG. 4, as shown by operation 410, the apparatus 200 may include means, such as entropy quality circuitry 212 or the like, for in the instance in which the first entropy source does not meet the set of requirements and the first priority value is the greatest known priority value, determining whether an admixture meeting the set of requirements is possible to generate based on the set of entropy sources. In some embodiments, the entropy quality circuitry 212 may utilize stored data relating to properties of the available entropy sources, including intrinsic properties and the current status of various entropy sources (e.g., downtime, network issues, or the like). The entropy quality circuitry 212 may determine whether an admixture of entropy sources may be able to satisfy the set of requirements (e.g., in a blocking case or an unblocking case). The admixture may combine two or more entropy streams into a single stream, allowing a greater rate of entropy production and an entropy quality determined by the quality of the input entropy streams, which may provide the properties needed to meet requirements of a request for entropy. For example, the entropy quality circuitry 212 may compute qualities of potential admixtures based on the available entropy sources to check whether potential admixtures may satisfy the requirements of the request for entropy.

In some embodiments, an admixture may be determined even in cases where it is possible to meet the requirements of the request for entropy without an admixture. For example, a request for entropy may require an entropy quality at a much lower level than what is available from an active entropy source. Rather than use high-value, high-quality entropy from the available source to meet the request, the entropy quality circuitry 212 may determine an admixture of the high-quality entropy and a lower quality entropy that meets the requirements of the request for entropy. The entropy quality circuitry 212 may be triggered to determine the available admixture based on a combination of factors from the request for entropy and determinations from the priority circuitry 210 regarding the priority of various requests and relative value of available entropy sources. For example, the priority circuitry 210 may determine that the high-quality entropy source is rarely used at a particular time, so there is no need to create an admixture of high and low-quality entropy sources to fulfill a request. At other times, the priority circuitry 210 may highly prioritize the limited entropy supply of a high-quality source and may make frequent admixture to avoid fulfilling requests with entropy quality exceeding the requirements of the request.

In some embodiments, the first request further comprises an indication of an unblocking property. The unblocking property of the first request indicates to the routing circuitry 208 and other circuitry that, even if it is not possible to provide entropy meeting the first request for entropy, the first request should be fulfilled with entropy that does not meet the set of requirements. In such instances, the entropy quality circuitry 212 may attempt to determine an admixture, in connection with operation 410 and operation 420, based on available entropy sources (e.g., which may be provided by entropy provider 108A through entropy provider 108N).

As shown by operation 420, the apparatus 200 includes means, such as entropy quality circuitry 212 or the like, for determining a quality of the admixture based on the first priority, the minimum acceptable quality, and the maximum acceptable quality. In some embodiments, set of requirements further comprises a minimum acceptable quality and maximum acceptable quality. The set of requirements may specify a range of allowable qualities, which may cause the entropy quality circuitry 212 to determine a target quality within the range of allowable qualities upon receiving the request. The entropy quality circuitry 212 may determine the target quality based on a pre-determined function or rules-based method. For example, the entropy quality circuitry 212 may attempt to provide the greatest possible quality to each request while still maintaining the minimum quality needed to fulfill other requests. In another example, the entropy quality circuitry 212 may prioritize avoiding creating admixtures of entropy streams to reduce the computational workload needed to fulfill entropy requests.

As shown by decision block 430, control may depend on determining whether the admixture meeting the set of requirements is possible to generate based on the set of entropy sources (e.g., as determined in operation 410). In an instance in which the admixture is possible to generate, control may flow to operation 440. In an instance in which the admixture is not possible to generate, control may flow to operation 450.

As shown by operation 440, the apparatus 200 includes means, such as entropy quality circuitry 212, or the like, for, in an instance in which the first entropy source does not meet the set of requirements and first priority value is the greatest known priority value, generating or causing generation of an admixture of a plurality of entropy sources from the set of entropy sources, wherein the admixture meets the set of requirements. The entropy quality circuitry 212 may generate the admixture by combining several streams of entropy to form a single admixture stream of entropy. For example, the entropy quality circuitry 212 may perform an exclusive “or” operation on two entropy streams to create an admixture stream. The entropy quality circuitry 212 may use any method to combine multiple streams, which may take the form of a function ƒ, with ƒ:{0,1}^{N}→{0,1}, where N is the number of input streams. The function ƒ may be chosen based on the desired properties of the admixture stream, which may be, for example, preserving the quality of the input entropy streams. The function ‘ƒ’ may combine the bitstrings from various input streams using one or more of sub-functions such as one or more of concatenation, XOR operation, Cryptographic Hash function, Key Derivation function, or random bit generator. The function ‘ƒ’ may also be setup to use a known bias either as per the explicit request received in the request datagram or implicitly based on policies identified in the configuration of entropy quality circuitry 212. The function ‘ƒ’ may further include a shaper that is based on the distribution requested based on the parameters specified in the request datagram received (e.g. if a normal distribution is requested, parameters could be the mean and the standard deviation). In some embodiments, the apparatus 200 may cause generation of the admixture by transmitting details of the admixture to an external device (e.g., a separate computing device and/or one or more of the entropy sources) to cause generation of the admixture.

As shown by operation 450, the apparatus 200 includes means, such as entropy quality circuitry 212, or the like, for, based on the determining that the admixture is not possible to generate, determining an unblocking admixture based on the set of requirements and the set of entropy sources. As described previously, the request for entropy may include an unblocking quality, which may indicate that the apparatus 200 should provide entropy even if requirements are unable to be met. The entropy quality circuitry 212 may, in addition to or instead of providing entropy from a source that does not meet the set of requirements, generate an admixture of entropy sources that does not meet the set of requirements to satisfy the unblocking entropy request. The admixture of entropy sources may provide an entropy stream that is closer to meeting the set of requirements than any individual entropy source. For example, an unblocking request may be received for 10 bits of entropy with quality 5 (in arbitrary units), while sources are available that may provide (a) 5 bits of entropy with quality 6 and (b) 20 bits of entropy with quality 1. The entropy quality circuitry 212 may, based on its configuration, either provide 10 bits of entropy with quality 4, or create an admixture of sources (a) and (b) to create an admixture with 10 bits of entropy with quality greater than 1 but less than 5. The entropy quality circuitry 212 may determine to create the admixture stream, for example, when high quality entropy is not available to meet the request, but the high-quality entropy is not currently under demand from other requests.

As shown by operation 460, the apparatus 200 includes means, such as communications hardware 206, or the like, for, providing, by to the endpoint device, an indication that the unblocking admixture does not meet the set of requirements. The communications hardware 206 may provide the indication, in some embodiments, that the unblocking admixture does not meet the set of requirements by transmitting a second datagram including the indication. In some embodiments, the indication may be attached to, or transmitted simultaneously with the unblocking admixture to the endpoint device. In instances in which a separate device provided the initial request for entropy, the indication may further be transmitted to the device that sent the original request for entropy.

As shown by operation 470, the apparatus 200 includes means, such as communications hardware 206, entropy quality circuitry 212, or the like, for causing generation of the admixture (e.g., the unblocking admixture) to create a mixed entropy stream. As described previously in connection with operation 440, the entropy quality circuitry 212 may generate or cause generation of the admixture, creating a mixed entropy stream formed by a plurality of entropy sources. The admixture may be the unblocking admixture determined in connection with operation 450.

As shown by operation 480, the apparatus 200 includes means, such as communications hardware 206, or the like, for providing the admixture to the endpoint device. In some embodiments, the communications hardware 206 may prepare and transmit the requested entropy admixture to the endpoint device directly, and in some embodiments, the communications hardware 206 may transmit commands causing one or more entropy sources or other dedicated devices to transmit the prepared admixture or mixed entropy stream to the one or more endpoint devices specified by the request for entropy.

Turning now to FIG. 5, as shown by operation 510, the apparatus 200 includes means, such as communications hardware 206, for, in an instance in which the first entropy source meets the set of requirements, providing entropy from the first source to the endpoint device. The communications hardware 206 may provide entropy as described above in connection with operation 480.

As shown by operation 520, the apparatus 200 includes means, such as communications hardware 206, for, in an instance in which the first priority is not the greatest available priority value, providing entropy according to a request with the greatest available priority. The communications hardware 206 may provide entropy as described above in connection with operation 480.

Turning now to FIG. 6, as shown by operation 610, the apparatus 200 includes means, such as memory 204, communications hardware 206, testing circuitry 214, or the like, for receiving a testing sample of entropy from the first entropy source. The communications hardware 206 may receive the testing entropy in connection with data indicating the presence of testing entropy, for example, to distinguish the testing entropy from other entropy streams. Additionally or alternatively, in some embodiments, the testing circuitry 214 may periodically designate a subset of entropy from an entropy source as testing entropy. The testing circuitry 214 may separate the testing entropy from other entropy sources, such as by storing the testing entropy in memory 204 or other storage.

As shown by operation 620, the apparatus 200 includes means, such as testing circuitry 214, or the like, for executing, by testing circuitry, a quality test based on the testing sample to determine a tested quality related to the first entropy source. In some embodiments, determining whether the first entropy source meets the set of requirements is further based on the tested quality related to the first entropy source. The testing circuitry 214 may conduct a battery of tests to determine the quality of the testing sample from the entropy source. The battery of tests may include a single test, or several tests, performed in succession or simultaneously. As an illustrative example, any number of the tests described in National Institute for Standards and Technology (NIST) special publication 800-22 may be implemented by testing circuitry 214. In some embodiments, results from various tests may be combined by an overall scoring function and/or classifier (e.g., a classifier implemented using machine learning) to determine an overall quality score. The testing circuitry 214 may also record a timestamp or timestamps associated with the statistical tests for quality.

As shown by operation 630, the apparatus 200 includes means, such as testing circuitry 214, or the like, for determining that the tested quality for the first entropy source was not determined within a pre-defined window of time, wherein each entropy source from the plurality of entropy sources has a corresponding particular tested quality that was determined within the pre-defined window of time, wherein the set of requirements further comprises a tested entropy requirement. In some embodiments, the request for entropy may specify that the entropy is required to be tested and, in some cases, may further specify that the entropy should be tested with a specified recency. The testing circuitry 214 may ensure the entropy is recently tested by checking the timestamp associated with the entropy testing occurs within the specified window of time. If the testing was not performed within the specified window of time, the entropy source may be re-tested and/or may be considered not suitable for the set of requirements associated with the request for entropy.

As shown by operation 640, the apparatus 200 includes means, such as memory 204, communications hardware 206, or the like, for receiving the indication of the quality of the entropy from the first entropy source. While entropy may be tested by the testing circuitry 214 as described in connection with operation 610 through operation 630, in some embodiments the entropy may be tested by the entropy source or by an external provider of testing (e.g., a cloud service or other provider). In such cases, the entropy source (or the other external provider) may provide an indication of the tested quality of the first entropy source. The indication of quality may indicate a timestamp of the entropy quality testing, or the testing circuitry 214 may apply a timestamp based on the time the testing quality indication was received.

In some embodiments, the set of entropy sources comprises an onsite entropy source and a cloud entropy source. In various embodiments, the entropy sources may be physical devices located on the same network or may be cloud services from outside providers. It will be understood that the operations of FIGS. 3-6 may be performed using onsite sources, cloud sources, and/or a combination of different types of sources.

Turning now to FIG. 7, a block diagram is shown indicating interactions among example systems in accordance with some example embodiments described herein. The blocks illustrated in FIG. 7 represent a conceptual view and indicate various interfaces and flows of data that may be embodied by the systems and apparatuses indicated, for example, in FIG. 1 and FIG. 2.

The entropy sources, including on-prem entropy source 702A, on-prem entropy source 702B, and cloud entropy source 702C, may be entropy providers (e.g., embodied by one or more of entropy provider 108A through entropy provider 108N) that are on-premises or cloud sources. The entropy sources may provide streams of entropy to an aggregation and caching platform 706, which may be a component of abstraction and orchestration 704 services (which may in turn be embodied by components of entropy service load balancing system 102). The aggregation and caching platform 706 may cache, buffer, and or mix the streams received from entropy sources and forward the streams to client frond end system APIs 710. Entropy QA 712A, entropy QA 712B, and entropy QA 712C may provide quality assurance of the entropy streams, measuring quality to ensure sorting into appropriate quality tiers, such as “best” entropy 714A, “better” entropy 714B, and/or “good” entropy 714C. A dashboard and management UI 708 may enable administrators access to configure and monitor the abstraction and orchestration 704 layer and the client front end system APIs 710. Outgoing entropy streams may be tested by entropy QA 716A, entropy QA 716B, and/or entropy QA 716C, for further QA to ensure quality through various caching and mixture operations performed by client frond end system APIs. Finally, entropy streams may be delivered to entropy client 718A, entropy client 718B, and/or entropy client 718C (which may be embodied, for example, by one or more endpoint device 106).

As mentioned, FIG. 7 illustrates a conceptual view, and the blocks shown in FIG. 7 may be embodied by various systems and devices shown in FIG. 1 and FIG. 2. For example, the on-prem entropy source 702A-702C may embodied by one or more of entropy provider 108A through entropy provider 108N. The entropy client 718A-718C may be embodied by one or more endpoint device 106. Other functions, interfaces, and such entities may be embodied by an entropy service load balancing system 102 (which in turn may be embodied by an apparatus 200). For example, the entropy service load balancing system 102 may perform some or all of the functions of abstraction and orchestration 704, aggregation and caching platform 706, dashboard and management UI 708, and/or client front end system APIs 710. Additionally, entropy service load balancing system 102, through its associated circuitry as embodied by apparatus 200, may perform functions of entropy QA 712A-712C and/or entropy QA 716A-716C.

### CONCLUSION

As described above, example embodiments provide methods and apparatuses that enable improved delivery and testing of entropy to clients. By providing a platform for processing requests for entropy and distributing entropy of varying qualities according to priorities assigned based on organization-level policies, example embodiments provide improvements to the way entropy is delivered to clients. As these examples all illustrate, example embodiments contemplated herein provide technical solutions that solve real-world problems faced in computing (e.g., cryptography and security, Monte Carlo calculations, and other applications requiring entropy of varying qualities). For example, embodiments disclosed herein enable more optimal use of limited entropy resources, reducing downtime and reducing the waste of high-quality entropy for use cases that only require low-quality entropy.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing entropy to clients, the method comprising:
receiving, by communications hardware, a first datagram comprising a first request for entropy and a set of requirements comprising an indication of an endpoint device, an indication of a number of bits of entropy, and an indication of a quality of the entropy;
determining, by routing circuitry, whether a first entropy source from a set of entropy sources meets the set of requirements;
determining, by priority circuitry, a first priority value based on the first request;
determining, by the priority circuitry, whether the first priority value is a greatest available priority value;
in an instance in which the first entropy source does not meet the set of requirements and the first priority value is the greatest available priority value, causing generation, by entropy quality circuitry, of an admixture of a plurality of entropy sources from the set of entropy sources, wherein the admixture meets the set of requirements; and
providing, by the communications hardware, the admixture to the endpoint device as a response to the first request.

2. The method of claim 1, wherein the set of requirements further comprises a minimum acceptable quality and maximum acceptable quality, the method further comprising:
determining, by the entropy quality circuitry, a quality of the admixture based on the first priority value, the minimum acceptable quality, and the maximum acceptable quality.

3. The method of claim 1, wherein the first request further comprises an indication of a blocking property, the method further comprising:
in the instance in which the first entropy source does not meet the set of requirements and the first priority value is the greatest available priority value, determining, by the entropy quality circuitry, that the admixture meeting the set of requirements is possible to generate based on the set of entropy sources.

4. The method of claim 1, wherein the first request further comprises an indication of an unblocking property, the method further comprising, in the instance in which the first entropy source does not meet the set of requirements and the first priority value is the greatest available priority value:
determining, by the entropy quality circuitry, that the admixture meeting the set of requirements is not possible to generate based on the set of entropy sources;
based on the determining that the admixture is not possible to generate, determining an unblocking admixture based on the set of requirements and the set of entropy sources; and
providing, by the communications hardware and to the endpoint device, an indication that the unblocking admixture does not meet the set of requirements.

5. The method of claim 1, further comprising:
receiving, by the communications hardware, a testing sample of entropy from the first entropy source; and
executing, by testing circuitry, a quality test based on the testing sample to determine a tested quality related to the first entropy source,
wherein determining whether the first entropy source meets the set of requirements is further based on the tested quality related to the first entropy source.

6. The method of claim 5, wherein the set of requirements further comprises a tested entropy requirement, the method further comprising:
determining, by the entropy quality circuitry, that the tested quality for the first entropy source was not determined within a pre-defined window of time,
wherein each entropy source from the plurality of entropy sources has a corresponding particular tested quality that was determined within the pre-defined window of time.

7. The method of claim 1, further comprising,
receiving, by the communications hardware, the indication of the quality of the entropy from the first entropy source.

8. The method of claim 1, wherein the set of entropy sources comprises an onsite entropy source and a cloud entropy source.

9. The method of claim 1, wherein the set of requirements further comprises an indication of a distribution and an indication of bias.

10. An apparatus for providing entropy to clients, the apparatus comprising:
communications hardware configured to receive a first datagram comprising a first request for entropy and a set of requirements comprising an indication of an endpoint device, an indication of a number of bits of entropy, and an indication of a quality of the entropy;
routing circuitry configured to determine whether a first entropy source from a set of entropy sources meets the set of requirements;
priority circuitry configured to:
determine a first priority value based on the first request, and
determine whether the first priority value is a greatest available priority value; and
entropy quality circuitry configured to, in an instance in which the first entropy source does not meet the set of requirements and the first priority value is the greatest available priority value, cause generation of an admixture of a plurality of entropy sources from the set of entropy sources, wherein the admixture meets the set of requirements,
wherein the communications hardware is further configured to provide the admixture to the endpoint device as a response to the first request.

11. The apparatus of claim 10, wherein the set of requirements further comprises a minimum acceptable quality and maximum acceptable quality, wherein the entropy quality circuitry is further configured to:
determine a quality of the admixture based on the first priority value, the minimum acceptable quality, and the maximum acceptable quality.

12. The apparatus of claim 10, wherein the first request further comprises an indication of a blocking property, wherein the entropy quality circuitry is further configured to:
in the instance in which the first entropy source does not meet the set of requirements and the first priority value is the greatest available priority value, determine that the admixture meeting the set of requirements is possible to generate based on the set of entropy sources.

13. The apparatus of claim 10, wherein the first request further comprises an indication of an unblocking property, wherein the entropy quality circuitry is further configured to, in the instance in which the first entropy source does not meet the set of requirements and the first priority value is the greatest available priority value:
determine that the admixture meeting the set of requirements is not possible to generate based on the set of entropy sources; and
based on the determining that the admixture is not possible to generate, determine an unblocking admixture based on the set of requirements and the set of entropy sources,
wherein the communications hardware is further configured to provide, to the endpoint device, an indication that the unblocking admixture does not meet the set of requirements.

14. The apparatus of claim 10,
wherein the communications hardware is further configured to receive a testing sample of entropy from the first entropy source,
wherein the apparatus further comprises testing circuitry configured to execute a quality test based on the testing sample to determine a tested quality related to the first entropy source,
wherein determining whether the first entropy source meets the set of requirements is further based on the tested quality related to the first entropy source.

15. The apparatus of claim 14, wherein the set of requirements further comprises a tested entropy requirement, wherein the entropy quality circuitry is further configured to:
determine that the tested quality for the first entropy source was not determined within a pre-defined window of time,
wherein each entropy source from the plurality of entropy sources has a corresponding particular tested quality that was determined within the pre-defined window of time.

16. The apparatus of claim 10, wherein the communications hardware is further configured to receive the indication of the quality of the entropy from the first entropy source.

17. The apparatus of claim 10, wherein the set of entropy sources comprises an onsite entropy source and a cloud entropy source.

18. A computer program product for providing entropy to clients, the computer program product comprising at least one non-transitory computer-readable storage medium storing software instructions that, when executed, cause an apparatus to:
receive a first datagram comprising a first request for entropy and a set of requirements comprising an indication of an endpoint device, an indication of a number of bits of entropy, and an indication of a quality of the entropy;
determine whether a first entropy source from a set of entropy sources meets the set of requirements;
determine a first priority value based on the first request;
determine whether the first priority value is a greatest available priority value;
in an instance in which the first entropy source does not meet the set of requirements and the first priority value is the greatest available priority value, cause generation of an admixture of a plurality of entropy sources from the set of entropy sources, wherein the admixture meets the set of requirements; and
provide the admixture to the endpoint device as a response to the first request.

19. The computer program product of claim 18, wherein the set of requirements further comprises a minimum acceptable quality and maximum acceptable quality, wherein the software instructions, when executed, further cause the apparatus to:
determine a quality of the admixture based on the first priority, the minimum acceptable quality, and the maximum acceptable quality.

20. The computer program product of claim 18, wherein the first request further comprises an indication of a blocking property, wherein the software instructions, when executed, further cause the apparatus to:
in the instance in which the first entropy source does not meet the set of requirements and the first priority value is the greatest available priority value, determine that the admixture meeting the set of requirements is possible to generate based on the set of entropy sources.
